(19) United States
(12) Patent Application Publication
(10) Pub. No.: US 2026/0151758 A1
(43) Pub. Date: Jun. 4, 2026

(54) TANTALUM AND NITROGEN CO-DOPED STRONTIUM TITANATE WITH PEROVSKITE STRUCTURE AND PREPARATION METHOD AND APPLICATION THEREOF

(71) Applicant: DALIAN INSTITUTE OF CHEMICAL PHYSICS, CHINESE ACADEMY OF SCIENCES, Dalian, Liaoning (CN)

(72) Inventors: Fuxiang ZHANG, Dalian, Liaoning (CN); Xueshang XIN, Dalian, Liaoning (CN)

(21) Appl. No.: 18/718,417

(22) PCT Filed: Dec. 13, 2023
(86) PCT No.: PCT/CN2023/138379

§ 371 Date: Jun. 10, 2024

(30) Foreign Application Priority Data
Jun. 12, 2023 (CN) 202310699193.3

(51) Int. Cl. B01J 27/24; B01J 23/44; B01J 23/46; B01J 35/39; B01J 37/00; B01J 37/02; B01J 37/04; B01J 37/06; B01J 37/08; B01J 37/18; B01J 37/34; C01B 3/046

(52) U.S. Cl. CPC B01J 27/24; B01J 23/44; B01J 23/468; B01J 35/39; B01J 37/009; B01J 37/0221; B01J 37/0236; B01J 37/04; B01J 37/06; B01J 37/086; B01J 37/18; B01J 37/343; C01B 3/046

(57) ABSTRACT

A tantalum and nitrogen co-doped strontium titanate with perovskite structure, is a photocatalytic material. Titanium isopropoxide and tantalum pentachloride are dissolved in methanol, then ethylene glycol, citric acid and strontium carbonate are added, a polymerization reaction product is calcined with air to remove organic carbon, and tantalum doped strontium titanate is obtained. The tantalum doped strontium titanate is mixed with magnesium powder and nitrided in an atmosphere of an ammonia gas flow. A nitrided product is acid-pickled, water-washed and dried, and the tantalum and nitrogen co-doped strontium titanate with perovskite structure is obtained. A titanium-oxygen bond is weakened by pre-doping tantalum, and a magnesium powder-assisted nitridation method is used, such that spatial distribution of a high-content nitrogen dopant in strontium titanate is realized.

### TECHNICAL FIELD

The present disclosure relates to a tantalum and nitrogen co-doped strontium titanate with perovskite structure, and a preparation method and application thereof, belonging to the technical field of photocatalytic materials.

### BACKGROUND

Photocatalytic water splitting is a sustainable and environmentally-friendly method to directly convert solar energy into chemical energy. Various photocatalysts have been developed over the past decades, such as metal oxides, metal oxysalts, (oxy)sulfides, (oxy)nitrides, oxyhalides, and metal-organic frameworks. Strontium titanate has attracted much attention on account of a proper energy band position, excellent photocatalytic performance and photochemical stability. The highest external quantum efficiency of photocatalytic overall water splitting using strontium titanate can reach 96% (at 360 nm) at present. However, since a light absorption ability of the strontium titanate is limited (an absorption edge wavelength is 390 nm), its solar-to-hydrogen efficiency is only 0.65%. Thus, it is a prerequisite to improve an ability of the strontium titanate to strongly absorb visible light for efficient photocatalysis. Metal ion doping is a common means to narrow a band gap of SrTiO₃, such as Mn, Ru, Rh, and Cr/Sb doping. However, light absorption caused by a localized state is finitely extended in a band gap. In addition to metal doping, anion doping, especially nitrogen doping, is also extensively applied to modify electronic structure to expand a light absorption range. However, light absorption of single-nitrogen-doped strontium titanate or La/N or Cr/N co-doped strontium titanate shows a shoulder shape only at 400 nm-550 nm so far, and band absorption having a broad spectral response has not yet been realized. The main reason is that it is difficult to introduce substitution nitrogen into the strontium titanate. The substitution nitrogen has low solubility because a dopant has a difficulty in diffusing from a surface of the strontium titanate to a body. The primary prerequisite for efficient photocatalytic overall water splitting is that semiconductor material has an ability to strongly absorb visible light. Therefore, it is still challenging and urgent to develop a new doping method to improve spatial distribution of nitrogen dopant in strontium titanate.

### SUMMARY

In order to solve the problem that existing nitridation methods cannot realize high-content nitrogen doping in strontium titanate, the present disclosure provides a tantalum and nitrogen co-doped strontium titanate with perovskite structure and a preparation method thereof. A titanium-oxygen bond is weakened by pre-doping tantalum, and a magnesium powder-assisted nitridation method is used, such that spatial distribution of a high-content nitrogen dopant in the strontium titanate is realized. According to the present disclosure, strontium titanate having a 600-nm-wide spectrum response is synthesized, which has potential application value in a photocatalytic reaction. In order to realize the above objective, the technical solution employed by the present disclosure is as follows:

A first aspect of the present disclosure provides a method for preparing a tantalum and nitrogen co-doped strontium titanate with perovskite structure. The method includes steps as follows:
S1. dissolving titanium isopropoxide and tantalum pentachloride in methanol, adding ethylene glycol and citric acid, and dissolving them fully to obtain a first solution;
S2. adding strontium carbonate into the first solution obtained in S1, dissolving the strontium carbonate fully to obtain a second solution;
S3. heating the second solution obtained in S2to 150° C.-200° C., maintaining the temperature for 0.1 h-5 h to carry out a polymerization reaction, and obtaining a polymer;
S4. heating the polymer obtained in S3 to a temperature of 300° C.-400° C. and maintaining the temperature for 0.5 h-2 h in a first stage for carbonization treatment, to a temperature of 500° C.-600° C. for 0.1 h-20 h in a second stage for removing carbon, and to a temperature of 800° C.-1100° C. for 0.1 h-20 h in a third stage to obtain oxide precursor powder;
S5. mixing and grinding the oxide precursor powder obtained in S4 with magnesium powder to obtain mixed powder;
S6. placing the mixed powder obtained in S5 into a tubular furnace and introducing ammonia gas for nitridation to obtain nitrided powder; and
S7. acid-pickling the nitrided powder in S6, followed by filtering, water-washing and drying the nitrided powder to obtain the tantalum and nitrogen co-doped strontium titanate with perovskite structure.

In the above technical solution, further, in step S1, a molar ratio of a total of the tantalum pentachloride and the titanium isopropoxide to the ethylene glycol to the citric acid is 1:15:60, and a molar ratio of tantalum in the tantalum pentachloride to titanium in the titanium isopropoxide is 0.001:0.999-0.1 0.9.

In the above technical solution, further, in step S2, a molar ratio of the strontium carbonate to the total of the tantalum pentachloride and the titanium isopropoxide is 1.03:1.

In the above technical solution, further, in step S5, a mass ratio of the magnesium powder to the oxide precursor powder is 0.5-10:1.

In the above technical solution, further, in step S6, a flow rate of the ammonia gas is 50 mL/min-500 mL/min, a nitridation temperature is 650° C.-800° C., nitridation time is 3 h-20 h, and a temperature increase rate is 5° C./min.

A second aspect of the present disclosure provides a tantalum and nitrogen co-doped strontium titanate with perovskite structure prepared through the aforementioned preparation method. A doping amount of tantalum in the tantalum and nitrogen co-doped strontium titanate with perovskite structure is 1 wt. %-10 wt. %, and a doping amount of nitrogen is 0.1 wt. %-5 wt. %.

A third aspect of the present disclosure provides a photocatalyst of tantalum and nitrogen co-doped strontium titanate with perovskite structure. The aforementioned tantalum and nitrogen co-doped strontium titanate with perovskite structure is used to support a precious metal or a metal oxide to obtain the photocatalyst of tantalum and nitrogen co-doped strontium titanate with perovskite structure.

In the above technical solution, further, the precious metal includes at least one of Ru, Rh, Pd, Ag, Ir, Pt and Au, and a loading amount of the precious metal is 0.01 wt. %-5 wt. %. The metal oxide includes at least one of CoOₓ, RuOₓ and IrOₓ, and a loading amount of the metal oxide is 0.01 wt. %-5 wt. %.

In the above technical solution, further, a method for supporting the precious metal includes dispersing tantalum and nitrogen doped strontium titanate powder in a solution containing precious metal precursor, followed by ultrasonic dispersion to obtain a dispersion liquid, then evaporative drying the dispersion liquid in a water bath, and carrying out reduction at 100° C.-400° C. for 0.5 h-3 h in a hydrogen gas flow.

A method for supporting the metal oxide includes dispersing tantalum and nitrogen doped strontium titanate powder in a solution containing metal precursor, followed by ultrasonic dispersion to obtain a dispersion liquid, then evaporative drying the dispersion liquid in a water bath, and carrying out calcining in an atmosphere of air, nitrogen gas or argon gas at 100° C.-500° C. for 0.5 h-4 h.

A fourth aspect of the present disclosure provides an application of the above photocatalyst of tantalum and nitrogen co-doped strontium titanate with perovskite structure in a photocatalytic hydrogen production, includes dispersing a hole sacrificial reagent and the photocatalyst powder in water to split the water under illumination to produce hydrogen. The hole sacrificial reagent is selected from one or more of lactic acid, sodium sulfide, ascorbic acid, formic acid, sodium formate, methanol, and triethanolamine.

A fifth aspect of the present disclosure provides an application of the above photocatalyst of tantalum and nitrogen co-doped strontium titanate with perovskite structure in a photocatalytic hydrogen production, includes dispersing a hole sacrificial reagent and the photocatalyst powder in water to split the water under illumination to produce oxygen. The hole sacrificial reagent is selected from one or more of silver nitrate, potassium iodate, and ferric chloride.

Beneficial effects of the present disclosure are as follows:
1. According to the present disclosure, the synthesis method has simple process, simple and convenient steps, and short preparation period, which facilitate large-scale industrial production.
2. According to the present disclosure, a titanium-oxygen bond is weakened by pre-doping tantalum, and magnesium powder-assisted nitridation is used to accelerate nitridation dynamics, such that a nitridation temperature can be effectively reduced, and nitridation time can be effectively shorted, avoiding the increase of defects caused by long-term high-temperature nitridation.
3. According to the present disclosure, spatial distribution of a high-content nitrogen dopant in strontium titanate is realized, so that the synthesized catalyst has a broader light absorption range and remarkable photocatalytic activity in photocatalytic water splitting for hydrogen production and water splitting for oxygen production.

### BRIEF DESCRIPTION OF THE DRAWINGS

FIG. 1 is a scanning electron microscope image of SrTiO₃:Ta(3%)/N synthesized in Example 1;

FIG. 2 is an x-ray diffraction (XRD) spectrum of SrTiO₃:Ta(3%)/N synthesized in Example 1;

FIG. 3 is an ultraviolet-visible (UV-Vis) absorption spectrum of SrTiO₃:Ta(3%)/N synthesized in Example 1;

FIG. 4 is a scanning electron microscope image of SrTiO₃:Ta(6%)/N synthesized in Example 2;

FIG. 5 is an x-ray diffraction (XRD) spectrum of SrTiO₃:Ta(6%)/N synthesized in Example 2;

FIG. 6 is an ultraviolet-visible (UV-Vis) absorption spectrum of SrTiO₃:Ta(6%)/N synthesized in Example 2;

FIG. 7 is a diagram showing hydrogen production activity of photocatalytic water splitting of SrTiO₃:Ta(6%)/N in Example 3;

FIG. 8 is a diagram showing oxygen production activity of photocatalytic water splitting of SrTiO₃:Ta(6%)/N in Example 4; and

FIG. 9 is a diagram showing hydrogen production activity of photocatalytic water splitting of SrTiO₃:N in Comparative Example 1.

### DETAILED DESCRIPTIONS OF THE EMBODIMENTS

The following non-limiting examples can enable those skilled in the art to more fully understand the present disclosure, but do not limit the present disclosure in any way.

### Example 1

S1. Titanium isopropoxide and tantalum pentachloride were dissolved in methanol to obtain a mixed solution, ethylene glycol and citric acid (a molar ratio of the titanium isopropoxide to the tantalum pentachloride to the ethylene glycol to the citric acid was 0.97:0.03:15:60) were added to the mixed solution, which were completely dissolved, and a first solution was obtained.
S2. After complete dissolution, strontium carbonate (a molar ratio of Sr to Ti to Ta was 1.03:0.97:0.03) was added to the first solution and completely dissolved, and a second solution was obtained.
S3. The second solution was heated after it became transparent. The second solution was heated to a temperature of 160° C. to reflux for 5 h, and a polymeric gel was formed.
S 4. The polymeric gel was further heated to evaporate the organic solvent until 350° C. The temperature of 350° C. was maintained for 2 h for pyrolysis. Obtained powder after pyrolysis was transferred to a corundum crucible, and the corundum crucible was placed in a muffle furnace for carbon removal. The obtained powder after pyrolysis was calcined in an atmosphere of air at 550° C. for 10 h, and then was calcined in an atmosphere of air at 1000° C. for 10 h, and an oxide precursor was obtained.
S5. Magnesium powder and the oxide precursor were mixed (a mass ratio of the magnesium powder to the oxide precursor was 2:1), and manually ground in an agate mortar for 30 min. Mixed powder was obtained.
S6. The mixed powder obtained in step S5 was placed in a corundum porcelain boat. The porcelain boat was placed in a central temperature control zone of a tubular furnace, an ammonia gas flow was introduced with a flow rate of 200 mL/min, and a temperature was increased to 700° C. at 5° C./min for nitridation for 10 h, followed by natural cooling to a room temperature.
S7. The nitrided powder was taken out and washed with 0.5 M of hydrochloric acid with stirring, then was centrifugally washed with water to be neutral, and the washed powder was dried to obtain the SrTiO₃:Ta(3%)/N powder.

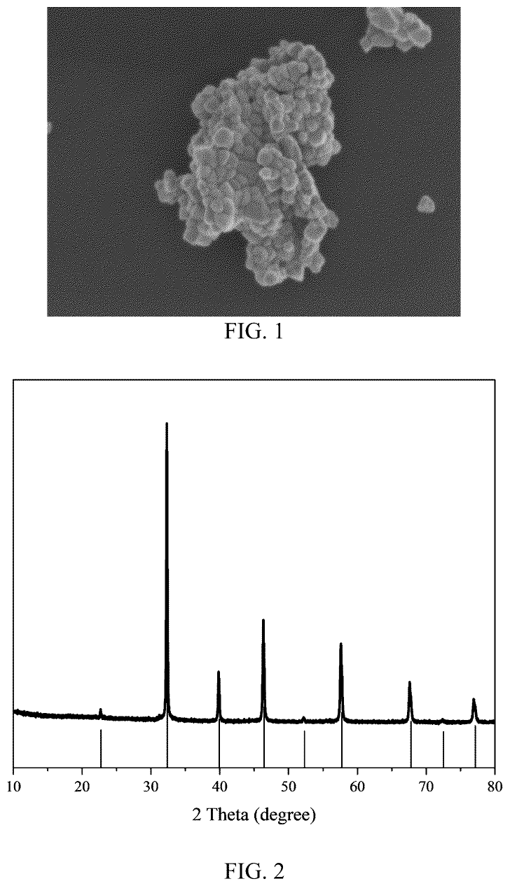

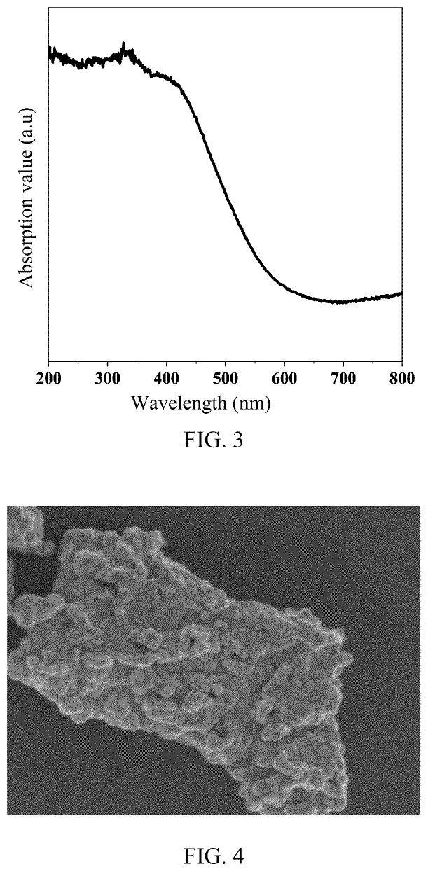

FIG. 1 is a scanning electron microscope image of SrTiO₃:Ta(3%)/N with perovskite structure synthesized in Example 1, showing that the SrTiO₃:Ta(3%)/N was formed by stacking nanoparticles. FIG. 2 is an x-ray diffraction (XRD) spectrum of SrTiO₃:Ta(3%)/N with perovskite structure synthesized in Example 1, which corresponds to a diffraction peak of a SrTiO₃ standard card PDF #89-4934, proving that pure-phase strontium titanate was synthesized. FIG. 3 is an ultraviolet-visible (UV-Vis) absorption spectrum of SrTiO₃:Ta(3%)/N with perovskite structure synthesized in Example 1, showing that an absorption edge of the SrTiO₃:Ta(3%)/N extended to 600 nm.

### Example 2

S1. Titanium isopropoxide and tantalum pentachloride were dissolved in methanol to obtain a mixed solution, ethylene glycol and citric acid (a molar ratio of the titanium isopropoxide to the tantalum pentachloride to the ethylene glycol to the citric acid was 0.94:0.06:15:60) were added to the mixed solution, which were completely dissolved, and a first solution was obtained.
S2. After complete dissolution, strontium carbonate (a molar ratio of Sr to Ti to Ta was 1.03:0.94:0.06) was added to the first solution and completely dissolved, and a second solution was obtained.

S3. The second solution was heated after it became transparent. The second solution was heated to a temperature of 160° C. to reflux for 5 h, and a polymeric gel was formed.
S4. The polymeric gel was further heated to evaporate the organic solvent until 350° C. The temperature of 350° C. was maintained for 2 h for pyrolysis. Obtained powder after pyrolysis was transferred to a corundum crucible, and the corundum crucible was placed in a muffle furnace for carbon removal. The obtained powder after pyrolysis was calcined in an atmosphere of air at 550° C. for 10 h, and then was calcined in an atmosphere of air at 1000° C. for 10 h, and an oxide precursor was obtained.
S5. Magnesium powder and the oxide precursor were mixed (a mass ratio of the magnesium powder to the oxide precursor was 2:1), and manually ground in an agate mortar for 30 min. Mixed powder was obtained.
S6. The mixed powder obtained in step S5was placed in a corundum porcelain boat. The porcelain boat was placed in a central temperature control zone of a tubular furnace, an ammonia gas flow was introduced with a flow rate of 200 mL/min, and a temperature was increased to 700° C. at 5° C./min for nitridation for 10 h, followed by natural cooling to a room temperature.
S7. The nitrided powder was taken out and washed with 0.5 M of hydrochloric acid with stirring, then was centrifugally washed with water to be neutral, and the washed powder was dried to obtain the SrTiO₃:Ta(6%)/N powder.

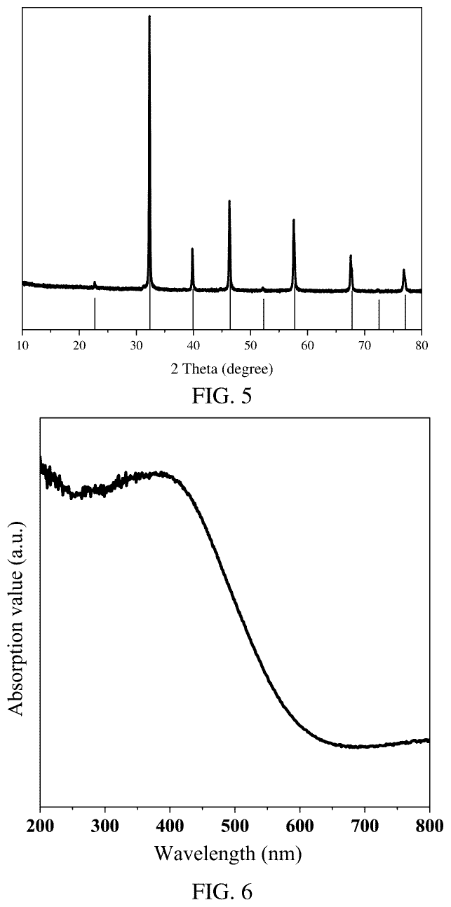

FIG. 4 is a scanning electron microscope image of SrTiO₃:Ta(6%)/N with perovskite structure synthesized in Example 2, showing that the SrTiO₃:Ta(3%)/N was formed by stacking nanoparticles. FIG. 5 is an x-ray diffraction (XRD) spectrum of SrTiO₃:Ta(6%)/N with perovskite structure synthesized in Example 2, which corresponds to a diffraction peak of a SrTiO₃ standard card PDF #89-4934, proving that pure-phase strontium titanate was synthesized. FIG. 6 is an ultraviolet-visible (UV-Vis) absorption spectrum of SrTiO₃:Ta(6%)/N with perovskite structure synthesized in Example 2, showing that an absorption edge of the SrTiO₃:Ta(6%)/N extended to 600 nm.

### Example 3

The SrTiO₃:Ta(3%)/N obtained in Example 2 was used for a photocatalytic hydrogen production test.

0.2 g of tantalum and nitrogen doped strontium titanate powder was ultrasonically dispersed in a sodium tetrachloropalladate solution containing 1 wt. % of Pd, and a mixed solution was obtained. The mixed solution was heated and evaporative dried in a water bath, and the dried product was reduced at 200° C. for 1 h under a mixed gas flow of hydrogen gas and argon gas to obtain a catalyst. A hydrogen gas preparation reaction of photocatalytic water splitting was carried out in a photocatalytic reactor having an on-line detection system. A reaction temperature was maintained at 15° C. Top irradiation was used for the reaction by a xenon lamp light source. 150 mg of catalyst powder supporting Pd was ultrasonically dispersed in 150 mL of a sodium formate solution having a concentration of 10 mM. The reaction system was vacuumized before illumination for removing air. Light in ultraviolet region was filtered out by a filter (λ≥420 nm). Hydrogen production activity of the photocatalyst under the condition of visible light was tested.

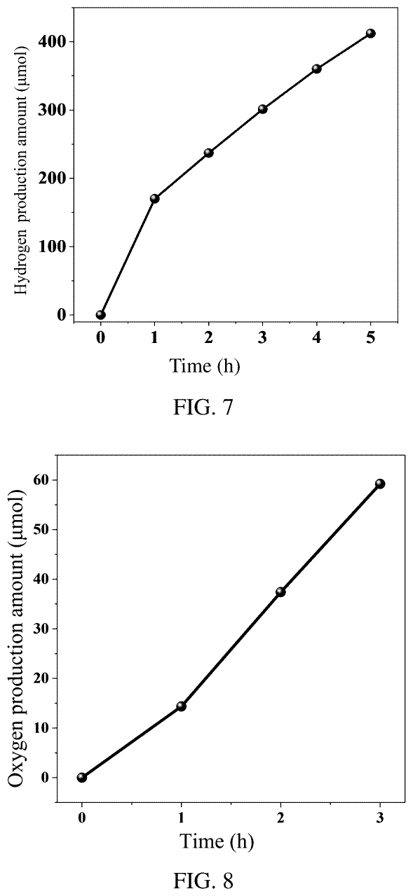

FIG. 7 is a diagram showing hydrogen production activity of photocatalytic water splitting of SrTiO₃:Ta(6%)/N in Example 3, showing that the catalyst can be applied to a hydrogen production of photocatalytic water splitting.

### Example 4

The SrTiO₃:Ta(3%)/N obtained in Example 2 was used for a photocatalytic hydrogen production test.

0.2 g of tantalum and nitrogen doped strontium titanate powder was ultrasonically dispersed in 1 wt. % of a iridium oxide colloidal solution and stirred continuously for 1 h under dark conditions. A hydrogen gas preparation reaction of photocatalytic water splitting was carried out in a photocatalytic reactor having an on-line detection system. A reaction temperature was maintained at 15° C. Top irradiation was used for the reaction by a xenon lamp light source. 50 mg of catalyst powder supporting yttrium oxide was ultrasonically dispersed in 150 mL of a silver nitrate solution having a concentration of 10 mM. The reaction system was vacuumized before illumination for removing air. Light in ultraviolet region was filtered out by a filter (λ≥420 nm). Hydrogen production activity of the photocatalyst under the condition of visible light was tested.

FIG. 8 is a diagram showing hydrogen production activity of photocatalytic water splitting of SrTiO₃:Ta(6%)/N in Example 4, showing that the catalyst can be applied to a hydrogen production of photocatalytic water splitting.

### Comparative Example 1

S1. Titanium isopropoxide was dissolved in methanol to obtain a mixed solution, ethylene glycol and citric acid (a molar ratio of the titanium isopropoxide to the ethylene glycol to the citric acid was 1:15:60) were added to the mixed solution, which were completely dissolved, and a first solution was obtained.
S2. After complete dissolution, strontium carbonate (a molar ratio of Sr to Ti was 1.03:1) was added to the first solution and completely dissolved, and a second solution was obtained.
S3. The second solution was heated after it became transparent. The second solution was heated to a temperature of 160° C. to reflux for 5 h, and a polymeric gel was formed.
S4. The polymeric gel was further heated to evaporate the organic solvent until 350° C. The temperature of 350° C. was maintained for 2 h for pyrolysis. Obtained powder after pyrolysis was transferred to a corundum crucible, and the corundum crucible was placed in a muffle furnace for carbon removal. The obtained powder after pyrolysis was calcined in an atmosphere of air at 550° C. for 10 h, and then was calcined in an atmosphere of air at 1000° C. for 10 h, and an oxide precursor was obtained.
S5. The oxide precursor was placed in a corundum porcelain boat. The porcelain boat was placed in a central temperature control zone of a tubular furnace, an ammonia gas flow was introduced with a flow rate of 200 mL/min, and a temperature was increased to 700° C. at 5° C./min for nitridation for 10 h, followed by natural cooling to a room temperature. A catalyst SrTiO₃:N powder was obtained.

The SrTiO₃:Ta(3%)/N obtained in Comparative Example 1 was used for a photocatalytic hydrogen production test.

0.2 g of nitrogen doped strontium titanate powder was ultrasonically dispersed in a sodium tetrachloropalladate solution containing 1 wt. % of Pd, and a mixed solution was obtained. The mixed solution was heated and evaporative dried in a water bath, and the dried product was reduced at 200° C. for 1 h under a mixed gas flow of hydrogen gas and argon gas to obtain a catalyst. A hydrogen gas preparation reaction of photocatalytic water splitting was carried out in a photocatalytic reactor having an on-line detection system. A reaction temperature was maintained at 15° C. Top irradiation was used for the reaction by a xenon lamp light source. 150 mg of catalyst powder supporting Pd was ultrasonically dispersed in 150 mL of a sodium formate solution having a concentration of 10 mM. The reaction system was vacuumized before illumination for removing air. Light in ultraviolet region was filtered out by a filter (λ≥420 nm). Hydrogen production activity of the photocatalyst under the condition of visible light was tested.

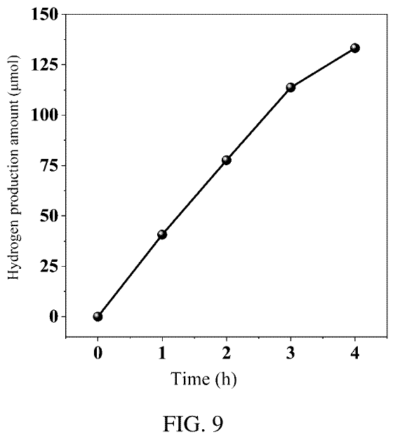

FIG. 9 is a diagram showing hydrogen production activity of photocatalytic water splitting of SrTiO₃:N in Comparative Example 1, showing that the catalyst powder obtained through a conventional nitridation method had a relatively poor activity.

The above embodiments are only used to illustrate the technical solutions of the present invention, but not to limit it; although the present invention has been described in detail with reference to the foregoing embodiments, those ordinarily skilled in the art should understand that: the technical solutions described in the foregoing embodiments can still be modified, or some or all of the technical features thereof can be equivalently replaced; and these modifications or replacements do not make the essence of the corresponding technical solutions deviate from the scope of the technical solutions of the embodiments of the present invention.

1. A method for preparing tantalum and nitrogen co-doped strontium titanate with perovskite structure, comprising steps as follows:
S1. dissolving titanium isopropoxide and tantalum pentachloride in methanol, adding ethylene glycol and citric acid, and dissolving them fully to obtain a first solution;
S2. adding strontium carbonate into the first solution obtained in S1, dissolving the strontium carbonate fully to obtain a second solution;
S3. heating the second solution obtained in S2 to 150° C.-200° C., maintaining the temperature for 0.1 h-5 h to carry out a polymerization reaction, and obtaining a polymer;
S4. heating the polymer obtained in S3 to a temperature of 300° C.-400° C. and maintaining the temperature for 0.5 h-2 h in a first stage, to a temperature of 500° C.-600° C. for 0.1 h-20 h in a second stage, and to a temperature of 800° C.-1100° C. for 0.1 h-20 h in a third stage to obtain oxide precursor powder;
S5. mixing and grinding the oxide precursor powder obtained in S4 with magnesium powder to obtain mixed powder;
S6. placing the mixed powder obtained in S5 into a tubular furnace and introducing ammonia gas for nitridation to obtain nitrided powder; and
S7. acid-pickling the nitrided powder in S6, followed by filtering, water-washing and drying the nitrided powder to obtain the tantalum and nitrogen co-doped strontium titanate with perovskite structure.

2. The method according to claim 1, wherein in step S1, a molar ratio of a total of the tantalum pentachloride and the titanium isopropoxide to the ethylene glycol to the citric acid is 1:15:60; and
a molar ratio of tantalum in the tantalum pentachloride to titanium in the titanium isopropoxide is 0.001:0.999-0.1:0.9.

3. The method according to claim 1, wherein in step S2, a molar ratio of the strontium carbonate to the total of the tantalum pentachloride and the titanium isopropoxide is 1.03:1.

4. The method according to claim 1, wherein in step S5, a mass ratio of the magnesium powder to the oxide precursor powder is 0.5-10:1.

5. The method according to claim 1, wherein in step S6, a flow rate of the ammonia gas is 50 mL/min-500 mL/min, a nitridation temperature is 650° C.-800° C., nitridation time is 3 h-20 h, and a temperature increase rate is 5° C./min.

6. A tantalum and nitrogen co-doped strontium titanate with perovskite structure prepared through the method according to claim 1, wherein a doping amount of tantalum in the tantalum and nitrogen co-doped strontium titanate is 1 wt. %-10 wt. %, and a doping amount of nitrogen is 0.1 wt. %-5 wt. %.

7. A photocatalyst of tantalum and nitrogen co-doped strontium titanate with perovskite structure, wherein the tantalum and nitrogen co-doped strontium titanate with perovskite structure according to claim 1 is used to support a precious metal or a metal oxide to obtain the photocatalyst of tantalum and nitrogen co-doped strontium titanate with perovskite structure.

8. The photocatalyst of tantalum and nitrogen co-doped strontium titanate with perovskite structure according to claim 7, wherein
a method for supporting the precious metal comprises dispersing tantalum and nitrogen doped strontium titanate powder in a solution containing precious metal precursor, followed by ultrasonic dispersion to obtain a dispersion liquid, then evaporative drying the dispersion liquid in a water bath, and carrying out reduction at 100° C.-400° C. for 0.5 h-3 h in a hydrogen gas flow; and
a method for supporting the metal oxide comprises dispersing tantalum and nitrogen doped strontium titanate powder in a solution containing metal precursor, followed by ultrasonic dispersion to obtain a dispersion liquid, then evaporative drying the dispersion liquid in a water bath, and carrying out calcining in an atmosphere of air, nitrogen gas or argon gas at 100° C.-500° C. for 0.5 h-4 h.

9. An application of the photocatalyst of tantalum and nitrogen co-doped strontium titanate with perovskite structure according to claim in a photocatalytic hydrogen production, comprising dispersing a hole sacrificial reagent and the photocatalyst powder in water to split the water under illumination to produce hydrogen, wherein the hole sacrificial reagent is selected from one or more of lactic acid, sodium sulfide, ascorbic acid, formic acid, sodium formate, methanol, and triethanolamine.

10. An application of the photocatalyst of tantalum and nitrogen co-doped strontium titanate with perovskite structure according to claim 7 in a photocatalytic oxygen production, comprising dispersing a hole sacrificial reagent and the photocatalyst powder in water to split the water under illumination to produce oxygen, wherein the hole sacrificial reagent is selected from one or more of silver nitrate, potassium iodate, and ferric chloride.
